(19) United States
(12) Patent Application Publication
(10) Pub. No.: US 2025/0131187 A1
(43) Pub. Date: Apr. 24, 2025

(54) CONDITIONING PROMPTS FOR GENERATIVE ARTIFICIAL INTELLIGENCE SYSTEMS FOR PRODUCTION OF STRUCTURED OUTPUT

(71) Applicant: INTERNATIONAL BUSINESS MACHINES CORPORATION, Armonk, NY (US)

(72) Inventors: Gennaro Anthony Cuomo, Raleigh, NC (US); Allen Vi Cuong Chan, Markham (CA); John Wright Stephenson, Blackstock (CA); Craig Salter, Hamilton (CA); Trevett Bradin Chusing, Grimsby (CA); Alexander Philip Samaha, Oakville (CA)

(21) Appl. No.: 18/490,426

(22) Filed: Oct. 19, 2023

(51) Int. Cl. G06F 40/186; G06F 40/20; G06N 3/0455

(52) U.S. Cl. CPC G06F 40/186; G06F 40/20; G06N 3/0455

(57) ABSTRACT

Conditioning prompts for generative artificial intelligence (AI) systems includes receiving a user prompt via a user interface. The user prompt is for a generative artificial intelligence system and is specified as natural language. A selected prompt class is chosen from a plurality of prompt classes by matching a natural language processing analysis of the user prompt to a prompt template of the selected prompt class. A well-structured prompt is created by transforming the user prompt based on the prompt template of the selected prompt class. A conditioned prompt is generated by combining a set of one or more conditioning instructions from the selected prompt class with the well-structured prompt. The conditioned prompt is submitted to the generative artificial intelligence system. The conditioned prompt is configured to evoke a response including a structured output from the generative artificial intelligence system.

### RESERVATION OF RIGHTS IN COPYRIGHTED MATERIAL

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

This disclosure relates to generative artificial intelligence (AI) systems and, more particularly, to conditioning prompts for generative AI systems for production of structured output.

AI refers to the science and engineering of making intelligent machines such as intelligent computer programs executing on data processing systems. Advances in large language models (LLMs) and natural language processing (NLP) have allowed generative AI systems to engage in conversations with human beings and generate human-like responses. These generated responses are conversational in nature. While generative AI systems accel at generating conversational output, the non-deterministic nature of such systems makes them less capable of reliably generating more formal or structured output. Asking a generative AI system to produce structured output such as program code compatible with a particular computer-based system, for example, does not provide reliable results.

A variety of existing technologies attempt to coax more formal outputs from generative AI systems. These existing technologies tend to rely on overly complex algorithms and involve time-consuming pre-processing operations. Even still, these technologies are unable to cause the generative AI systems to produce structured output that is compatible with, and may be reliably consumed by, downstream computer systems. Thus, it becomes necessary for users to manually intervene, fix, and/or transform the generative AI system output before downstream computer systems are able to consume that output. This inability to reliably generate compatible structured output for downstream computer systems introduces further complexity in terms of troubleshooting and consumes greater computational resources and time.

### SUMMARY

In one or more embodiments, a method includes receiving a user prompt via a user interface. The user prompt is for a generative artificial intelligence system and is specified as natural language. The method includes choosing a selected prompt class from a plurality of prompt classes by matching a natural language processing analysis of the user prompt to a prompt template of the selected prompt class. The method includes creating a well-structured prompt by transforming the user prompt based on the prompt template of the selected prompt class. The method includes generating a conditioned prompt by combining a set of one or more conditioning instructions from the selected prompt class with the well-structured prompt. The method includes submitting the conditioned prompt to the generative artificial intelligence system. The conditioned prompt is configured to evoke a response including a structured output from the generative artificial intelligence system.

The foregoing and other implementations can each optionally include one or more of the following features, alone or in combination. Some example implementations include all the following features in combination.

In some aspects, the prompt template specifies a prompt structure for the conditioned prompt.

In some aspects, the prompt template includes a field that is populated by a keyword obtained from the natural language processing analysis of the user prompt.

In some aspects, the generative artificial intelligence system is a large language model.

In some aspects, the structured output of the generative artificial intelligence system is compatible with a particular computer system and is specific to the selected prompt class.

In some aspects, the set of one or more conditioning instructions is specific to the selected prompt class.

In some aspects, the conditioned prompt is configured to reduce non-determinism in the response generated by the generative artificial intelligence system.

In some aspects, the method includes submitting the response from the generative artificial intelligence system to an evaluation system with an evaluator question extracted from the selected prompt class.

In some aspects, the evaluation system is a generative artificial intelligence system.

In some aspects, the method includes modifying the set of one or more conditioning instructions based on an evaluation result generated by the evaluation system.

In one or more embodiments, a system includes one or more processors configured to perform executable operations as described within this disclosure.

In one or more embodiments, a computer program product includes a computer readable storage medium having program instructions stored thereon. The program instructions are executable by one or more processors to cause the one or more processors and/or computer hardware to execute operations as described within this disclosure.

This Summary section is provided merely to introduce certain concepts and not to identify any key or essential features of the claimed subject matter. Other features of the inventive arrangements will be apparent from the accompanying drawings and from the following detailed description.

### BRIEF DESCRIPTION OF THE DRAWINGS

FIG. 1 illustrates an example architecture for conditioning prompts for a generative artificial intelligence (AI) system.

FIG. 2 illustrates an example message flow among the various components of the architecture of FIG. 1.

FIG. 3 illustrates an example of a prompt class as instantiated by the conditioner of FIGS. 1 and 2.

FIG. 4 illustrates an example method illustrating certain operative features of the conditioner of FIGS. 1 and 2.

FIG. 5 illustrates an example of a structured output as generated by the generative AI system of FIG. 1 responsive to receiving a conditioned prompt.

FIG. 6 illustrates an example of a computing environment.

### DETAILED DESCRIPTION

While the disclosure concludes with claims defining novel features, it is believed that the various features described within this disclosure will be better understood from a consideration of the description in conjunction with the drawings. The process(es), machine(s), manufacture(s) and any variations thereof described herein are provided for purposes of illustration. Specific structural and functional details described within this disclosure are not to be interpreted as limiting, but merely as a basis for the claims and as a representative basis for teaching one skilled in the art to variously employ the features described in virtually any appropriately detailed structure. Further, the terms and phrases used within this disclosure are not intended to be limiting, but rather to provide an understandable description of the features described.

This disclosure relates to generative artificial intelligence (AI) systems and, more particularly, to conditioning prompts for generative AI systems for production of structured output. As defined within this disclosure, the term “structured output” means data generated by a generative AI system that conforms to a particular structure or syntax, and that is consumable (e.g., readable) by a computer system. Examples of structured output may include, but are not limited to, data specified in a particular programming language, in a particular markup language, or other computer notation, data organized into a data structure such as an array or vector, or data having another predetermined organization or formatting.

The structured output may be directly consumed as input by one or more other computer systems (e.g., computer programs). The inventive arrangements facilitate human-computer communication using Natural Language Processing (NLP) by allowing a generative AI system to transform natural language input, e.g., a prompt, from a user into precise, structured output such as machine-readable instructions and/or computer-readable instructions.

In accordance with the inventive arrangements described within this disclosure, methods, systems, and computer program products are described that are capable of conditioning user prompts for a generative AI system. The inventive arrangements utilize a matching technique that pairs the user provided prompt with a particular prompt template. The matching ensures that the user prompt is transformed into a well-structured prompt capable of consistently producing a desired type and/or quality of output from a generative AI system. The conditioning may include additional instructions that account for unique characteristics and/or peculiarities of the particular generative AI system being used and/or the task or query to be performed by the generative AI system as specified by the user prompt.

In one or more example implementations, prompt template to which the user prompt is matched belongs to a prompt class type of data structure. The prompt class, as selected, may include the instructions, e.g., as predetermined conditioning instructions, that can be added to the user prompt. Use of the prompt template in combination with the conditioning instructions addresses, at least in part, the non-determinism of the generative AI system such that reliable and predictable structured output may be obtained.

The inventive arrangements are also capable of implementing a feedback mechanism. The feedback mechanism involves providing the structured output from the generative AI system to an evaluation system along with one or more predetermined evaluation questions. The evaluation questions may be obtained from the selected prompt class matched to the user prompt. The evaluation questions guide the evaluation system through the evaluation process to provide an evaluation result, e.g., feedback. Based on the feedback from the evaluation system, the conditioning instruction(s) of the prompt class(es) may be modified. The iterative aspect of incorporating feedback from the evaluation system facilitates ongoing enhancements and continued improvement to the prompt classes by way of modifying the conditioning instructions to achieve improved performance from the generative AI system over time.

The prompts, as conditioned and consumed by the generative AI system as input, cause the generative AI system to produce structured output. This structured output may be directly consumed by computer-based system(s) (e.g., computer programs). These features work together to deliver more precise and contextually appropriate output thereby making communication between humans and computers more streamlined and efficient. The need for manual intervention to correct erroneous or incompatible output from the generative AI system is reduced. That is, the mechanisms for conditioning user prompts and/or the feedback mechanisms may be implemented automatically. The inventive arrangements reduce computational overhead by allowing systems to interact seamlessly. Moreover, the inventive arrangements allow users of a variety of different skill levels (e.g., in terms of systems integration, programming, and/or computer science) to interact with the generative AI system to produce a variety of different types of structured outputs.

Further aspects of the embodiments described within this disclosure are described in greater detail with reference to the figures below. For purposes of simplicity and clarity of illustration, elements shown in the figures have not necessarily been drawn to scale. For example, the dimensions of some of the elements may be exaggerated relative to other elements for clarity. Further, where considered appropriate, reference numbers are repeated among the figures to indicate corresponding, analogous, or like features.

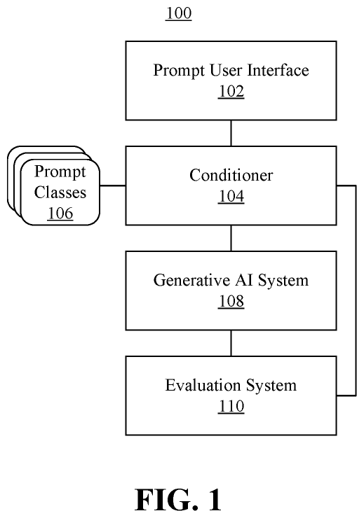

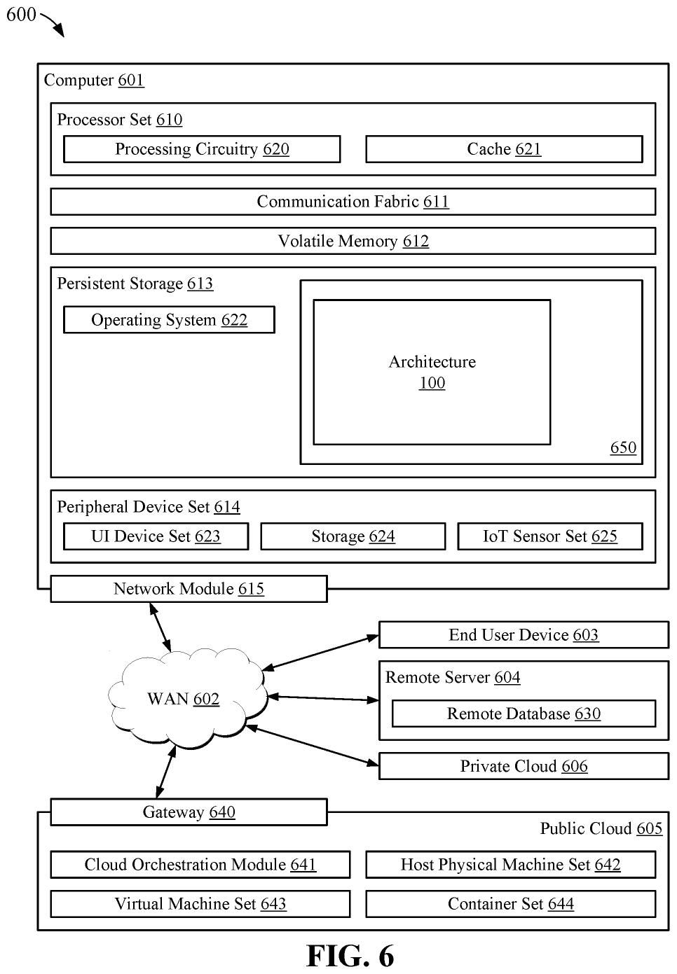

FIG. 1 illustrates an example architecture 100 for conditioning prompts for a generative AI system. Architecture 100 may be implemented as computer-readable instructions that may be executed by one or more interconnected data processing systems to perform the various operations described herein. An example of a data processing system is described herein in connection with FIG. 6. Architecture 100 includes a prompt user interface 102, a conditioner 104, a plurality of prompt classes 106, a generative AI system 108, and an evaluation system 110.

Architecture 100 allows a user to program a computer system through unstructured, conversational interactions with generative AI system 108. The user does not require extensive programming knowledge to do so. Generative AI system 108 may be implemented as any of a variety of Large Language Models (LLMs). A non-exhaustive list of example LLMs include, but are not limited to, Chat Generative Pre-trained Transformer (ChatGPT and/or subsequent iterations thereof) available from OpenAI, the FLAN-T5 transformer available on the Hugging Face community as set forth in the paper entitled “Scaling Instruction-Finetuned Language Models,” Bidirectional Encoder Representations from Transformer (BERT) models, and/or Llama 2.

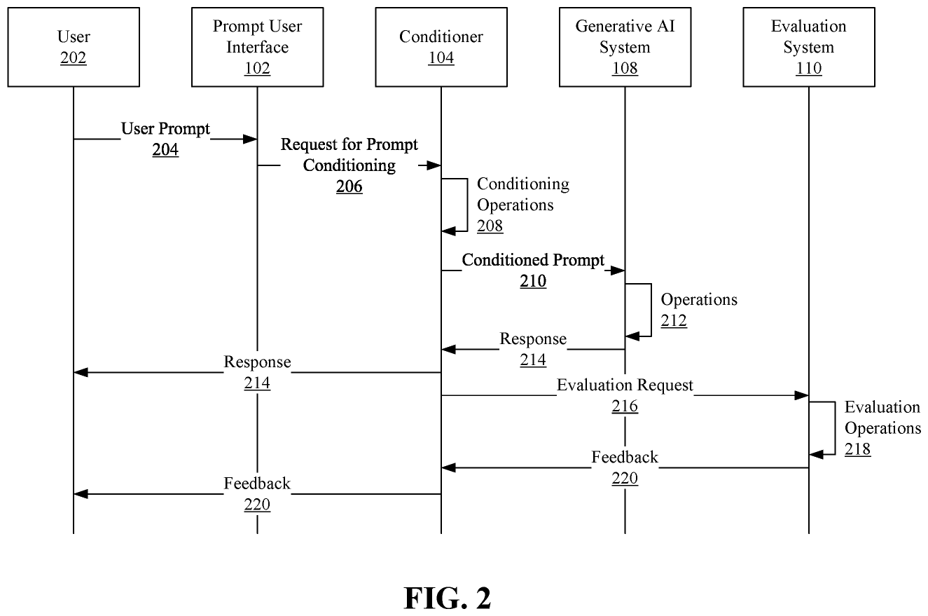

FIG. 2 illustrates an example message flow among the various components of architecture 100. Referring to FIGS. 1 and 2 collectively, a user 202 may enter a user prompt 204 into prompt user interface 102. Prompt user interface 102 is operative as an entry point for receiving user prompts. The user prompts may be specified as natural language whether directly as textual input or by conversion of received user speech into text. For example, user 202 may speak or type user prompt 204 into a data entry field of prompt user interface 102. User prompt 204 is intended to be conveyed to generative AI system 108 to evoke a structured output therefrom.

For purposes of illustration, an example of user prompt 204 may be “create a workflow to process insurance claims” and “generate a Business Process Model and Notation (BPMN) diagram that outlines the steps required to complete the workflow.” In this case, user 202 is requesting that generative AI system 108 create a structured output specified in BPMN format that defines a workflow for processing insurance claims. The structured output, having a specific format and syntax, may then be supplied to a downstream computer-based system.

In another example, user 202 may wish to create a user interface as a wireframe design for a particular operating system. The user interface is to accept inputs such as a user identifier and a password. User 202 may provide a natural language input such as “design user interface wireframes for a mobile operating system app with login functionality, including fields for user ID and password” as user prompt 204. In this example, the phrase “mobile operating system” may specify a particular or vendor-specific mobile operating system. Architecture 100 is capable of transforming user prompt 204 into another prompt version referred to herein as a “conditioned prompt” that, when provided to generative AI system 108 as input, causes generative AI system 108 to reliably generate a structured output which, in this example, may be a precise Scalable Vector Graphics (SVG) representation of the wireframes. The wireframes generated may be specifically tailored for consumption by a particular downstream computer-based tool. That is, the formal output generated by generative AI system 108 may be syntactically correct input that is compatible with the downstream computer-based tool.

Continuing with FIG. 2, prompt user interface 102 submits user prompt 204 to conditioner 104 as a request for prompt conditioning 206. Conditioner 104 facilitates the generation of precise and contextually appropriate responses by generative AI system 108 that meet the requirements of downstream systems or applications. In response to receiving the request for prompt conditioning 206, conditioner 104 operates on user prompt 204 by performing one or more conditioning operations 208. The conditioning performed on user prompt 204 may be considered “pre-conditioning” in that the conditioning is applied to user prompt 204 prior to user prompt 204 reaching generative AI system 108.

In one or more examples, conditioner 104 is capable of matching user prompt 204 to a selected prompt class from a plurality of available prompt classes 106. Conditioner 104 transforms the unstructured user prompt 204 into a conditioned prompt 210 using the selected prompt class. In general, the conditioning operations 208 involved in generating conditioned prompt 210 include translating user prompt 204 into a well-structured prompt based on a prompt template from the selected prompt class. Conditioner 104 adds one or more preconditioning instructions as specified by the selected prompt class to the well-structured prompt to form conditioned prompt 210.

In response to generating conditioned prompt 210, conditioner 104 submits conditioned prompt 210 to generative AI system 108. Generative AI system 108, in response to receiving conditioned prompt 210, performs operations 212 to generate a response 214. Response 214 may be provided to evaluation system 110. In the example, response 214 is provided to conditioner 104. Conditioner 104 is capable of forwarding response 214 to user 202 (e.g., forwarding response 214 to a user system (e.g., end user device (EUD) 603 of FIG. 6) for presentation through a user interface such as prompt user interface 102 or another suitable interface.

Conditioner 104 is also capable of retrieving one or more predetermined evaluation questions from the selected prompt class and providing response 214 in combination with the one or more evaluation questions to evaluation system 110 as evaluation request 216. Evaluation system 110 consumes response 214 and the one or more evaluation questions from evaluation request 216 as input and performs evaluation operations 218 to generate feedback 220. Feedback 220 may specify one or more additional conditioning instructions to be added to the selected prompt class, one or more conditioning instructions to replace existing conditioning instruction(s) of the selected prompt class, or instructions to remove or delete one or more conditioning instructions of the selected prompt class based on the evaluation of response 214 by evaluation system 110. Evaluation system 110 may perform the evaluation based on, or using, the one or more evaluation questions as a guide.

In the example, evaluation system 110 may be implemented as a generative AI system. In one or more examples, evaluation system 110 may be implemented as an LLM. In one aspect, evaluation system 110 may be implemented as the same LLM as generative AI system 108. In another aspect, evaluation system 110 may be implemented using a different LLM as generative AI system 108.

As described in greater detail below, conditioner 104 is optionally capable of initiating an evaluation of any response generated by generative AI system 108 in response to conditioned prompt 210. The evaluation, e.g., evaluation operations 218, may be performed based on the one or more evaluation questions obtained from the selected prompt class. Thus, the particular prompt class that is selected for a given user prompt 204 facilitates the generation of the well-structured prompt generated from the user prompt 204, specifies the conditioning instructions to be included with the well-structured prompt, and also may specify the particular evaluation questions (e.g., metrics) used to evaluate the response solicited from generative AI system 108 using conditioned prompt 210.

The particular message flow illustrated in FIG. 2 is provided for purposes of illustration. In other example implementations, other alternative message flows may be implemented. For example, generative AI system 108 may provide response 214 directly to evaluation system 110 rather than first providing response 214 to conditioner 104. In that case, conditioner 104 may provide the one or more evaluation questions as extracted from the selected prompt class to evaluation system 110 for use in evaluating response 214. A common and unique identifier may be used and included in response 214 that may be paired with the one or more evaluation questions as forwarded by conditioner 104 so that the one or more evaluation questions may be paired with the response 214 being evaluated. In one or more other embodiments, conditioner 104 may provide conditioned prompt 210 to user 202. Conditioned prompt 210 may be provided to user 202, for example, with response 214 and/or with feedback 220.

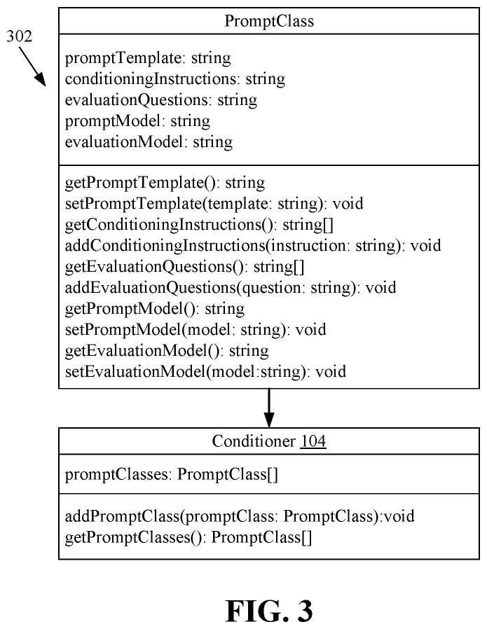

FIG. 3 illustrates an example of a prompt class 302 as instantiated by conditioner 104. Within conditioner 104, prompt classes 302 facilitate the handling of free-form utterances and the generation of computer-consumable responses by generative AI system 108. Prompt classes 302 are specifically designed to meet the requirements of various applications, such as making Application Programming Interface (API) calls, defining data structures like JSON, or creating computer notations like BPMN, SVG, or Mermad.js. Each prompt class 302 may include components such as a prompt template (promptTemplate) and conditioning instructions (contintioningInstructions). Each prompt class 302 may optionally include one or more or each of the following data items in any combination: evaluation questions (evaluationQuestions), prompt model (promptModel), and evaluation model (evaluationModel).

Each prompt class includes a prompt template that represents an expected or optimal prompt structure for the application corresponding to the prompt class. In one aspect, the prompt structure refers to a grammatical structure of text. The prompt structure specified by the prompt template may be used to create the well-structured portion of the conditioned prompt 210. Each prompt class includes a set of one or more conditioning instructions. The conditioning instructions ensure that the resulting prompt is well-formed and conforms to the desired format. The conditioning instructions are specific to the selected prompt class. That is, conditioning instructions and the prompt template are specific to the particular type of structured output that is to be generated by generative AI system 108 and, as such, may be specific to the selected prompt class. The conditioning instructions may be continually enhanced through the feedback mechanisms described herein. The feedback mechanisms consider past usage and performance. By incorporating input (e.g., feedback 220) from evaluation system 110, the conditioning instructions may evolve over time to achieve better results.

Each prompt class may include a set of one or more evaluation questions. The set of evaluation questions are provided to, and used by, evaluation system 110 to assess and evaluate the overall results of the conditioned prompt 210. The evaluation questions specify the metrics used to evaluate response 214 serve as a catalyst for the feedback loop and help drive continuous improvement in the prompt generation process. For example, for a prompt class related to making API calls, an evaluation question may be “does the generated response include all the necessary parameters and specifications required for the API call?”

Each prompt class optionally specifies a prompt model. The prompt model parameter specifies the particular generative AI system (e.g., LLM) with which the prompt class is to be used. Each prompt class optionally specifies an evaluation model. In cases where architecture 100 includes a plurality of different available generative AI systems 108, the prompt model parameter of each prompt class allows architecture 100 to dynamically select the particular generative AI system 108 to which conditioned prompt 210 is directed based on the prompt class matched to user prompt 204. That is, responsive to matching a prompt class to user prompt 204, the particular generative AI system 108 to which conditioned prompt 210 is directed is determined from the prompt model parameter.

The evaluation model parameter specifies the particular generative AI system (e.g., LLM) to be used as evaluation system 110 to evaluate the response generated by generative AI system 108. Thus, in cases where architecture 100 includes a plurality of different available evaluation systems 110, the evaluation model parameter of each prompt class allows architecture 100 to dynamically select the particular evaluation system 110 used to evaluate response 214 based on the prompt class matched to user prompt 204. That is, responsive to matching a prompt class to user prompt 204, the particular evaluation system 110 used to evaluate response 214 is determined from the evaluation model parameter.

In one or more embodiments, each prompt class 106 may correspond to a particular type of structured output that may be generated by generative AI system 108 for consumption by a computer-based system. Below is a non-exhaustive list of example prompt classes and the structured output each such prompt class may cause generative AI system 108 to generate in response to conditioned prompt 210.

A Structured Query Language (SQL) prompt class capable of causing generative AI system 108 to generate an SQL query as a response to facilitate database interactions.

A Hypertext Markup Language (HTML)/Cascading Style Sheets (CSS) prompt class capable of causing generative AI system 108 to generate well-structured HTML/CSS code as a response to facilitate website or application design.

A data visualization prompt class capable of causing generative AI system 108 to generate structured data visualizations such as charts or graphs.

A Machine Learning Model Architecture Generation prompt class capable of causing generative AI system 108 to generate structured machine learning model architectures. The machine learning model architectures may correspond to, or comply with, particular model specifications that may be prompt class-specific.

A business process model prompt class capable of causing generative AI system 108 to generate BPMN as a response to described specific workflows and/or computer-based processes.

A network diagram prompt class capable of causing generative AI system 108 to generate structured network diagrams specifying nodes and connections as a response to facilitate creation of network infrastructure.

A user interface prototype prompt class capable of causing generative AI system 108 to generate structured user interface prototypes as a response to facilitate rapid design iterations.

A software code snippet prompt class capable of causing generative AI system 108 to generate structured program code (e.g., source code) snippets as a response in a selected programming language. Further, different prompt classes may be created for different programming languages. Different prompt classes may be created to accommodate different types of functions and/or algorithms.

A data transformation mapping prompt class capable of causing generative AI system 108 to generate structured data transformation mappings as a response. Different prompt classes may be created to generate data transformation mappings between different data format and/or schemas.

A test case prompt class capable of causing generative AI system 108 to generate structured test cases for software testing. Different prompt classes may be created where each prompt class corresponds to a different test case that tests for a different scenario.

The foregoing examples illustrate the versatility and broad applicability of the inventive arrangements in that structured output may be obtained for a variety of different domains. This reduces and/or streamlines human-computer interactions. Appreciably, different prompt classes correspond to different types of structured outputs, may designate appropriate generative AI systems 108, and further designate appropriate evaluation systems 110 using the aforementioned parameters.

Referring again to FIG. 3, prompt class 302 may include a variety of different functions that may be called/invoked by conditioner 104 once an instance of prompt class 302 is instantiated. These functions include, but are not limited to:

getPromptTemplate: returns the prompt template of the prompt class.

setPromptTemplate: sets the prompt template for the prompt class.

getConditioningInstructions: returns the conditioning instructions of the prompt class.

addConditioningInstructions: adds the conditioning instructions to the conditioned prompt 210 being generated.

getEvaluationQuestions: returns the evaluation question(s) for the prompt class.

addEvaluationQuestions: adds the evaluation question(s) to the evaluation request being generated.

getPromptModel: returns the name and/or address of the generative AI system 108 to be used. This function may be used in cases where the system supports more than one generative AI system 108. This function is optional.

setPromptModel: sets the name and/or address of the generative AI system 108 to be used. The conditioned prompt is directed to the particular generative AI system setup through this function. This function may be used in cases where the system supports more than one possible generative AI system 108. This function is optional.

getEvaluationModel: returns the name and/or address of the generative AI system to be used as evaluation system 110. This function may be used in cases where the system supports more than one possible evaluation system. This function is optional.

setEvaluationModel: sets the name and/or address of the generative AI system to be used as evaluation system 110. The evaluation request is directed to the particular evaluation system specified through this function. This function may be used in cases where the system supports more than one possible evaluation system. This function is optional.

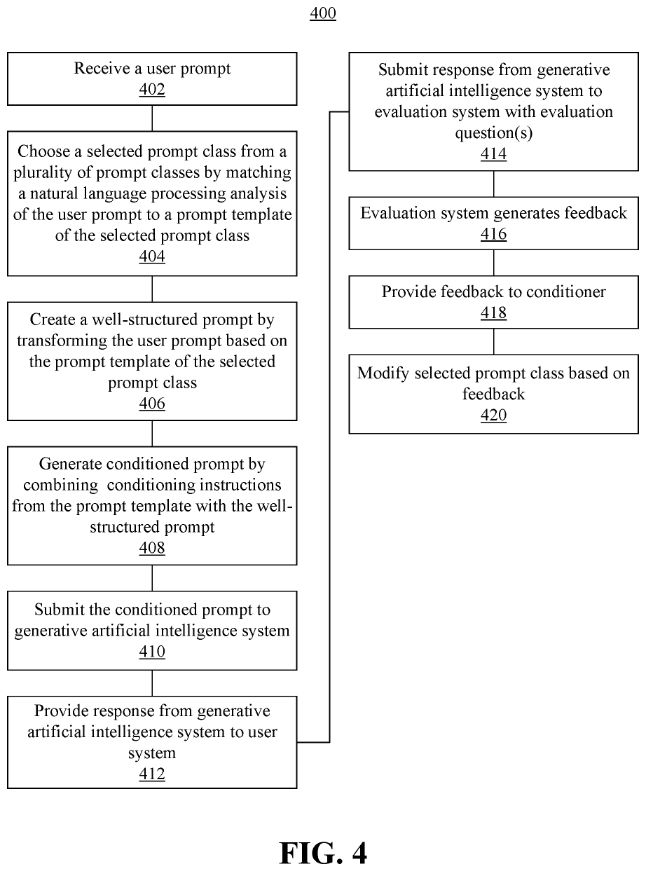

FIG. 4 illustrates an example method 400 illustrating certain operative features of conditioner 104 of FIG. 1. In block 402, conditioner 104 receives user prompt 204. For example, user 202 may provide natural language text or an utterance as user prompt 204 into a data entry field of prompt user interface 102.

In one or more examples, as part of block 402, conditioner 104 is capable of actively interacting with user 202 via prompt user interface 102. For example, conditioner 104 may provide guidance to user 202 that guides or suggests that the user provide input that aligns or corresponds to available prompt classes 106 and/or prompt templates of such prompt classes. Conditioner 104 is capable of offering suggestions or instructions to help user 202 frame the natural language input appropriately to align with an available one of the prompt classes 106. As an illustrative and nonlimiting example, the guidance may include an instructional label above the data entry field that shows a desired syntax (or syntaxes) for the user input to achieve a desired direct communication with a downstream computer program.

In one or more other embodiments, conditioner 104 is capable of processing general natural language inputs from user 202. Such general natural language inputs are not restricted to a particular prompt class 106. This flexibility allows architecture 100 to accommodate a wider variety of user prompts, preferences, and needs. By actively soliciting user 202 to provide a better formed user prompt 204 (e.g., a “best possible” prompt), conditioner 104 ensures that user prompt 204 aligns with a selected prompt class and the prompt template of the selected class. Providing user 202 with guidance as to prompt syntax and prompt class alignment helps architecture 100 generate more accurate and contextually appropriate responses from generative AI system 108. Such responses will be tailored to the specific application or desired outcome of user 202.

In block 404, conditioner 104 chooses a selected prompt class from the plurality of prompt classes 106 by matching a natural language processing (NLP) analysis of user prompt 204 to a prompt template of the selected prompt class. In one or more embodiments, conditioner 104 is capable of matching user prompt 204 to a particular prompt template of a prompt class (e.g., the selected prompt class). Conditioner 104 is capable of performing NLP analysis on user prompt 204. For example, conditioner 104 may perform operations such as keyword extraction, keyword comparison, tokenization, and/or part-of-speech tagging. Any of a variety of standard NLP software libraries may be used to implement such functions. For purposes of illustration and not limitation, the Natural Language Toolkit (NLTK) library for NLP is an example of such a library.

Conditioner 104 is capable of comparing the NLP analysis of user prompt 204 with the prompt templates of the different ones of the plurality of prompt classes 106. More particularly, conditioner 104 is capable of comparing the NLP analysis of user prompt 204 with the prompt templates of the plurality of prompt classes 106 to determine a matching prompt template. The comparison performed may involve iterating through a collection of prompt classes if multiple actions are allowed. In another example, the comparison performed may involve selecting a single prompt class in the case where the application is more constrained.

In one or more embodiments, conditioner 104 is capable of considering several different factors during the matching process. These factors may include, but are not limited to, overall structure of user prompt 204 and the structure of prompt template(s) and/or relevant keywords of user prompt 204 with text and/or available fields within the prompt template(s). By using these multiple factors in the matching process, conditioner 104 ensures that the well-structured prompt ultimately generated from user prompt 204 aligns with the desired format and structure specified by the prompt template.

For example, consider the case where user prompt 204 is “start with an approval task, followed by a review task, and end with a final approval task.” In this example, the matching process performed by conditioner 104 identifies a prompt template having a similar structure and containing keywords related to approval and workflow. Based on this match, conditioner 104 is capable of generating a well-structured prompt using the prompt template of the matched prompt class.

As an illustrative example, if user prompt 204 is “create a workflow for expense approval,” conditioner 104 may, through NLP analysis, detect keywords such as “workflow” and “expense approval.” Conditioner 104 may compare the keywords with the prompt templates of prompt classes 106 or a set of relevant prompt classes. In response to finding a prompt template with matching keywords and structure, conditioner 104 chooses the prompt class with the matching prompt template as the selected prompt class.

As part of block 404, conditioner 104 may generate an instance of the selected prompt class. For example, conditioner 104 may search the different prompt classes using the “getPromptClasses” function and instantiate the selected prompt class using the “addPromptClass” function.

In block 406, conditioner 104 creates a well-structured prompt by transforming user prompt 204 based on the prompt template of the selected prompt class. The prompt template is configured to evoke a response including a structured output from generative AI system 108. Conditioner 104 is capable of integrating the relevant components of user prompt 204, e.g., keywords, into appropriate fields of the prompt template. That is, conditioner 104 is capable of populating fields of the prompt template with the relevant keywords extracted from user prompt 204 based on the NLP analysis. Conditioner 104 performs the integration also ensuring proper sequencing and formatting. As an example, the well-structured prompt generated from user prompt 204 (“start with an approval task, followed by a review task, and end with a final approval task”) may be “start with an expense approval task, followed by a review of the expense details, and end with a final approval task for the expense.” The resulting well-structured prompt aligns with the prompt template of the selected prompt class and captures the desired workflow structure. In general, the prompt template may be completed by populating fields with keywords extracted from user prompt 204 to form the well-structured prompt.

The transformation of user prompt 204 into a well-structured prompt ensures that conditioned prompt 210 being generated aligns with a desired format and structure corresponding to the selected prompt class. User 202 may not be familiar, however, with this format or structure. For example, user 202 may wish to generate a BPMN diagram or SVG notation for a development project but be unfamiliar with such notation(s). Conditioner 104 ensures that the conditioned prompt 210, as output, is optimized for a particular application. Conditioner 104 effectively bridges any gap between user 202's natural language input and the specific requirements of the downstream systems or applications. As further discussed, below, conditioner 104 provides a clear and precise prompt in the form of conditioned prompt 210 to generative AI system 108 so that generative AI system 108 generates accurate and contextually appropriate responses.

In one or more examples, as part of block 406, conditioner 104 may invoke the “getPromptTemplate” function to retrieve the prompt template. Conditioner 104 may generate the well-structured prompt by invoking the “setPromptTemplate” function to insert the keywords extracted from user prompt 204 into the prompt template to generate the well-structured prompt.

In block 408, conditioner 104 generates conditioned prompt 210 by combining conditioning instructions from the selected prompt class with the well-structured prompt. Conditioner 104 takes the well-structured prompt generated in block 406, obtains any conditioning instructions specified in the selected prompt class, and combines two components to form conditional prompt 210. For example, as part of block 408, conditioner 104 may invoke the “getConditioningInstructions” function to retrieve the conditioning instructions for the selected prompt class. Conditioner 104 may invoke the “addConditioningInstructions” function to add the conditioning instructions to the well-structured prompt to generate the conditioned prompt 210.

As discussed, the conditioning instructions are a predefined set of prompt instructions specifically designed to guide generative AI system 108 in generating a response. The conditioning instructions ensure that the response is a well-formed, structured output that meets the desired format or structure corresponding to the selected prompt class. The conditioning instructions may specify particular requirements such as “generate the output in BPMN notation” or “assign each step a new ID.” The conditioning instructions may specify that “the output should focus solely on the notation without including any explanations or other unnecessary verbiage.” The conditioned prompt 210, including both the well-structured prompt and the conditioning instructions, ensures that generative AI system 108 generates a response that adheres to the desired format, structure, and specific requirements outlined by the selected prompt class.

Different generative AI systems often exhibit a unique set of response patterns owing to the type of data used to train the model. The conditioning instructions also may address the model-specific aspects of the response patterns to ensure that the desired structured output, compatible with the downstream system, is obtained.

In block 410, conditioner 104 submits conditioned prompt 210 to generative AI system 108. Conditioner 104, for example, may invoke an API of generative AI system 108 to submit conditioned prompt 210 thereto. In the case where a single generative AI system 108 is available, conditioned prompt 210 may be provided directly to generative AI system 108. In the case where multiple generative AI systems 108 are available, conditioned prompt 210 may be provided to the generative AI system 108 specified by the prompt model parameter from the selected prompt class.

In block 412, response 214 as generated by generative AI system 108 may be provided to user 202 (e.g., to EUD 603). In one example, generative AI system 108 provides response 214 to conditioner 104, which in turn provides response 214 to user 202 (e.g., EUD 603). In another example, generative AI system 108 provides response 214 directly to user 202 (e.g., to EUD 603).

In block 414, conditioner 104 submits response 214 with one or more evaluation questions to evaluation system 110. For example, in block 414, conditioner 104 is capable of retrieving the set of one or more evaluation questions for the selected prompt class. Conditioner 104 may use the “getEvaluationQuestions” function to retrieve the set of evaluation questions. Conditioner 104 may use the “addEvaluationQuestions” function to add the evaluation functions to response 214 to form evaluation request 216, which is provided to evaluation system 110. In the case where a single evaluation system is available, evaluation request 216 may be provided directly to the evaluation system. In the case where multiple evaluation systems are available, evaluation request 216 may be provided to the evaluation system specified by the evaluation model parameter from the selected prompt class.

In block 416, evaluation system 110 generates an evaluation result as feedback 220. In the example, evaluation system 110 may be implemented as another generative AI system. For example, evaluation system 110 also may be implemented as an LLM. The type of generative AI system used to implement evaluation system 110 may be the same as that used to implement generative AI system 108 or may be a different type of generative AI system.

Evaluation system 110 receives, as input, evaluation request 216, which includes response 214 and the set of one or more evaluation question(s) extracted from the selected prompt class. As noted, the evaluation question(s) are a predefined set of prompt-specific evaluation questions designed to cause evaluation system 110 to evaluate the quality and effectiveness of the generated prompts. The evaluation questions serve as a guideline for evaluation system 110 to assess response 214 based on specific criteria. The evaluation questions are designed to evaluate factors such as prompt completeness, accuracy, relevance, and adherence of response 214 to the desired format or requirements of downstream computer systems.

In block 418, feedback 220 is provided from evaluation system 110 to conditioner 104. Conditioner 104, in response to receiving feedback 220, is capable of updating the set of one or more conditioning instructions of the selected prompt class based on feedback 220. For example, feedback 220 may specify an additional conditioning instruction to be added to the conditioning instructions of the selected prompt class, specify a replacement conditioning instruction for a conditioning instruction of the selected prompt class, and/or specify that a conditioning instruction be deleted from the selected prompt class.

In block 420, conditioner 104 modifies the selected prompt class based on the feedback 220 provided from evaluation system 110. For example, conditioner 104 modifies the conditioning instructions of the selected prompt class based on feedback 220. By leveraging the evaluation questions, evaluation system 110 is capable of systematically evaluating response 214 and identifying any areas that require refinement or improvement. The feedback loop implemented using evaluation system 110 enables the continuous enhancement of the prompt generation process and ensures that the conditioned prompts 210, as generated, are of high quality and effectively serve their intended purpose.

The inventive arrangements described herein improve human-computer interactions and reduce the computational costs incurred through the invocation of generative AI systems such as LLMs. That is, LLMs are computationally expensive to operate. By ensuring that the desired structured output is obtained from the generative AI system earlier, e.g., in response to a first prompt, the number of interactions with the generative AI system may be reduced. This not only enhances the efficiency of the system by allowing the generative AI system to respond to a larger number of requests (e.g., different requests rather than responding to the same or similar request as the user “fine tunes” or refines the request) but also provides a cost-effective approach to generating structured responses.

For purposes of illustration, consider another example where user prompt 204 is “create a diagram for an order to cash process.” In this example, conditioner 104 matches user prompt 204 with the prompt template of “create a BPMN diagram for the {process} business process.” In this example, conditioner 104 extracts the keywords “diagram” and “process,” indicating an intent to create a business process diagram. Conditioner 104 matches user prompt 204 to the prompt template designed for creating BPMN diagrams. In this example, user prompt 204 did not specify BPMN. Rather, conditioner 104 infers this based on the matching that is performed. The prompt template includes a placeholder, {process}, which represents the specific business process to be diagrammed. In our example, the placeholder will be populated with “order to cash” to create the well-structured prompt “create a BPMN diagram for an order to cash business process.”

In this example, the selected prompt class, i.e., the prompt class having the matched prompt template, includes conditioning instructions as follows:
Respond only with notation. No explanations or additional text.
Assign each step a unique name or ID.
Specify the type of task for each step, such as user task, system task, exclusive gateway, or end event.
Specify the sequence and dependencies of each step using arrows or other connectors.
Optionally, include any input or output parameters for each step.

In this example, conditioned prompt 210 will be “Create a BPMN diagram for the ‘order to cash’ business process. Respond with the notation only. Assign each step a unique name or ID. Specify the type of task for each step, such as user task, system task, exclusive gateway, or end event. Specify the sequence and dependencies of each step using arrows or other connectors. Optionally, include any input or output parameters for each step.”

The well-structured prompt is formed of the prompt template with keywords of user prompt 204 incorporated into the field(s) therein. The well-structured prompt is combined with the conditioning instructions which are particular for creating a BPMN diagram. This ensures that generative AI system 108 receives the necessary information and instructions to generate a highly structured and contextually appropriate BPMN diagram for the “order to cash” business process.

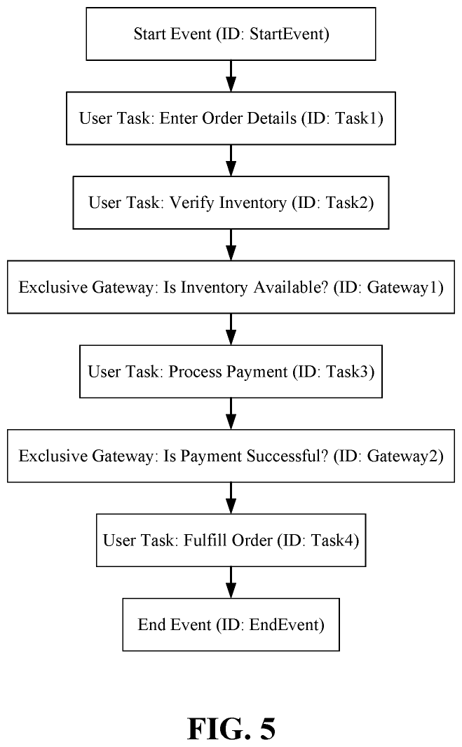

FIG. 5 illustrates an example BPMN diagram as generated by generative AI system 108 responsive to receiving the conditioned prompt 210. The example of FIG. 5 illustrates the case in which conditioner 104, by matching user prompt 204 with an appropriate prompt template and incorporating the precondition instructions, facilitates the generation of a highly structured and contextually appropriate BPMN diagram that is suitable for efficient communication with, and consumption by, a downstream data processing system. In this example, the requesting user did not have to specify the particular format or syntax of the output (e.g., BPMN in this example).

For purposes of illustration, consider another example relating to evaluation system 110. As noted, in some implementations, evaluation system 110 may be the same generative AI system as generative AI system 108. In other examples, evaluation system 110 may be different from generative AI system 108 if concerns over bias are an issue. As an illustrative example, evaluation system 110 may be implemented as a Falcon series open source LLM. Evaluation system 110 incorporates the evaluation questions and provides a structured approach to measure the performance and efficacy of conditioned prompt 210 by evaluating response 214 against the evaluation questions. Through this evaluation process, insights and feedback are obtained, which can be used to refine the list of conditioning instructions and overall prompt generation methodology.

In one or more example implementations, to ensure that the suggestions from evaluation system 110 may be consistently included as new entries in the conditioning instructions of the selected prompt class, a similar technique of conditioning, or preconditioning as the case may be, may be used by the result evaluator. As an example, the evaluation questions may include appended conditioning instructions such as: “List additions as short sentences,” “Do not include duplicate ideas from existing list of conditioning instructions,” or the like.

Example 1 below illustrates example feedback 220 that may be obtained from evaluation system 110 in evaluating the BPMN diagram of FIG. 5.

### Example 1

After evaluating the generated BPMN diagram provided above, the response evaluator identifies a potential improvement in the prompt template to enhance the quality and completeness of the generated diagram. The evaluator suggests updating the prompt template to include the specific requirement of indicating the start and end events in the diagram, as well as specifying the type of task for each step.
Add Conditioning Instructions:
   Include the start and end events in the diagram.
   Specify the type of task for each step.

In Example 1, conditioner 104 may update the conditioning instructions of the selected prompt class by adding the two suggested conditioning instructions thereto.

In another example, a different type of prompt class may be considered that plots results in a pie chart using Mermaid.js. The conditioned prompt 210 may be generated as “Create a pie chart to visualize the distribution of sales by product category.” Example 2 below illustrates example feedback 220 that may be obtained from evaluation system 110 in evaluating the result obtained using the conditioned prompt 210 “Create a pie chart to visualize the distribution of sales by product category.”

### Example 2

Following the evaluation of the generated prompt, the response evaluator concludes that it successfully fulfills the requirements for creating a pie chart. The prompt effectively conveys the objective of visualizing sales distribution by product category. However, to enhance the prompt class and provide more specific guidance, the evaluator suggests incorporating a tool, such as Mermaid.js, for future pie chart creation prompts. This recommendation is then included as a preconditioning instruction within the corresponding prompt class.
Added Conditioning Instruction:
   Create pie charts using Mermaid.js

By employing the feedback mechanisms illustrated in connection with evaluation system 110, architecture 100 is capable of iteratively improving the prompt generation process through the fine tuning of conditioning instructions. This ensures that the generated prompts meet the desired criteria, resulting in precise, contextually appropriate, and machine-consumable output for downstream systems or applications.

In another example, a user may submit a user prompt 204 to generate a structured API call. In this example, user prompt 204 may be “What is the current weather like in San Francisco?” In this case, conditioner 104 matches user 202 with a prompt template corresponding to a prompt class for a highly structured CURL command for an API call. Conditioner 104 generates a well-structured prompt and adds the conditioning instructions shown below in Example 3.

### Example 3

Generate a CURL command to invoke the Open WeatherMap API.
Include the appropriate API endpoint and method.
Provide the required query parameters for the API call.

In this case, generative AI system 108, in consuming conditioned prompt 210, generates a highly structured CURL command for an API call. Example 4 illustrates sample output from generative AI system 108 in response to conditioned prompt 210.

### Example 5

“curl-X GET “http://api.openweathermap.org/data/2.5/weather?q=San % 20Francisco&appid=<your_api_key>”

In this example, the conditioning instructions were predetermined for generating API calls via CURL. The instructions did not specify a particular API endpoint, allowing generative AI system 108 to select a suitable endpoint based on the system's judgment. In other examples, if a specific API endpoint is recommended, the conditioning instructions can be adjusted to specify a particular API endpoint.

In other examples, generative AI system 108 may prompt user 202 for additional information, such as an API key, if necessary to generate the CURL command correctly. Conditioner 104 is capable of dynamically adjusting the conditioning instructions based on the nature of the input prompt to ensure that the output obtained from generative AI system 108 is precisely structured and easily usable in downstream systems.

In another example, user prompt 204 may relate to data mapping and/or transformation functions. In the example below, data is to be transformed from a first format to a second and different format. User 202 may wish to create a data mapping that is precisely structured and directly usable in a downstream system. An example of conditioned prompt 210 that may be submitted to generative AI system 108 is shown below in Example 6.

### Example 6

Prompt: “I have these two structures . . .
source: (customer (givenName, surname), address (street, city, state, country, zipCode))
target: (address (provinceOrState, country, townOrCity, postalCode, street))”
Generate a data mapping without any explanations.
Identify matching fields in the source and target structures, such as customer.givenName to address.provinceOrState, and address.street to address.street.
For any fields without a direct match, identify any necessary transformations or mappings, such as mapping address.state to address.provinceOrState using a lookup table.
Assign a unique name or ID to each field.
Specify the data type and format for each field, such as string, integer, or date.
Optionally, specify default or fallback values for each field.

Example output generated in response to conditioned prompt 210 is shown below in Example 7.

### Example 7

{‘address/provinceOrState’: ‘address.state’, ‘address/country’: ‘address.country’, ‘address/townOrCity’: ‘address.city’, ‘address/postalCode’: ‘address.zipCode’, ‘address/street’: ‘address.street’, ‘customer/givenName’: ‘address.provinceOrState’}

The foregoing examples illustrate further applications and benefits of the inventive arrangements. The inventive arrangements streamline workflows, whether programming and/or data mapping, reduce the need for manual interventions, and minimize potential errors in data processing. In certain embodiments, by virtue of the feedback mechanisms described herein, the inventive arrangements are capable of dynamically adjusting the conditioning instructions based on the nature of the input prompt to ensure that the output is correctly structured and usable in downstream systems.

FIG. 6 illustrates an example of a computing environment 600. Computing environment 600 contains an example of an environment for the execution of at least some of the computer code in block 650 involved in performing the inventive methods, such as the entirety of architecture 100 illustrated in block 650, which may be implemented as executable program code or instructions. In one or more other examples, block 650 may implement prompt user interface 102 and/or conditioner 104 therein (e.g., only prompt user interface 102 and conditioner 104) and operate with one or more other systems that implement generative AI system 108 and/or evaluation system evaluation system 110 (e.g., as may be implemented in other computers, remote servers 604, public clouds 605, and/or private clouds 606). In addition to block 650, computing environment 600 includes, for example, computer 601, wide area network (WAN) 602, end user device (EUD) 603, remote server 604, public cloud 605, and private cloud 606. In this embodiment, computer 601 includes processor set 610 (including processing circuitry 620 and cache 621), communication fabric 611, volatile memory 612, persistent storage 613 (including operating system 622 and block 650, as identified above), peripheral device set 614 (including user interface (UI) device set 623, storage 624, and Internet of Things (IoT) sensor set 625), and network module 615. Remote server 604 includes remote database 630. Public cloud 605 includes gateway 640, cloud orchestration module 641, host physical machine set 642, virtual machine set 643, and container set 644.

Computer 601 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 630. As is well understood in the art of computer technology, and depending upon the technology, performance of a computer-implemented method may be distributed among multiple computers and/or between multiple locations. On the other hand, in this presentation of computing environment 600, detailed discussion is focused on a single computer, specifically computer 601, to keep the presentation as simple as possible. Computer 601 may be located in a cloud, even though it is not shown in a cloud in FIG. 6. On the other hand, computer 601 is not required to be in a cloud except to any extent as may be affirmatively indicated.

Processor set 610 includes one, or more, computer processors of any type now known or to be developed in the future. Processing circuitry 620 may be distributed over multiple packages, for example, multiple, coordinated integrated circuit chips. Processing circuitry 620 may implement multiple processor threads and/or multiple processor cores. Cache 621 is memory that is located in the processor chip package(s) and is typically used for data or code that should be available for rapid access by the threads or cores running on processor set 610. Cache memories are typically organized into multiple levels depending upon relative proximity to the processing circuitry. Alternatively, some, or all, of the cache for the processor set may be located “off chip.” In some computing environments, processor set 610 may be designed for working with qubits and performing quantum computing.

Computer readable program instructions are typically loaded onto computer 601 to cause a series of operational steps to be performed by processor set 610 of computer 601 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 621 and the other storage media discussed below. The program instructions, and associated data, are accessed by processor set 610 to control and direct performance of the inventive methods. In computing environment 600, at least some of the instructions for performing the inventive methods may be stored in block 650 in persistent storage 613.

Communication fabric 611 is the signal conduction paths that allow the various components of computer 601 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 612 is any type of volatile memory now known or to be developed in the future. Examples include dynamic type random access memory (RAM) or static type RAM. Typically, the volatile memory is characterized by random access, but this is not required unless affirmatively indicated. In computer 601, the volatile memory 612 is located in a single package and is internal to computer 601, but, alternatively or additionally, the volatile memory may be distributed over multiple packages and/or located externally with respect to computer 601.

Persistent storage 613 is any form of non-volatile storage for computers that is now known or to be developed in the future. The non-volatility of this storage means that the stored data is maintained regardless of whether power is being supplied to computer 601 and/or directly to persistent storage 613. Persistent storage 613 may be a read only memory (ROM), but typically at least a portion of the persistent storage allows writing of data, deletion of data and re-writing of data. Some familiar forms of persistent storage include magnetic disks and solid-state storage devices. Operating system 622 may take several forms, such as various known proprietary operating systems or open-source Portable Operating System Interface type operating systems that employ a kernel. The code included in block 650 typically includes at least some of the computer code involved in performing the inventive methods.

Peripheral device set 614 includes the set of peripheral devices of computer 601. Data communication connections between the peripheral devices and the other components of computer 601 may be implemented in various ways, such as Bluetooth connections, Near-Field Communication (NFC) connections, connections made by cables (such as universal serial bus (USB) type cables), insertion type connections (e.g., secure digital (SD) card), connections made though local area communication networks and even connections made through wide area networks such as the internet. In various embodiments, UI device set 623 may include components such as a display screen, speaker, microphone, wearable devices (such as goggles and smart watches), keyboard, mouse, printer, touchpad, game controllers, and haptic devices. Storage 624 is external storage, such as an external hard drive, or insertable storage, such as an SD card. Storage 624 may be persistent and/or volatile. In some embodiments, storage 624 may take the form of a quantum computing storage device for storing data in the form of qubits. In embodiments where computer 601 is required to have a large amount of storage (e.g., where computer 601 locally stores and manages a large database) then this storage may be provided by peripheral storage devices designed for storing very large amounts of data, such as a storage area network (SAN) that is shared by multiple, geographically distributed computers. IoT sensor set 625 is made up of sensors that can be used in Internet of Things applications. For example, one sensor may be a thermometer and another sensor may be a motion detector.

Network module 615 is the collection of computer software, hardware, and firmware that allows computer 601 to communicate with other computers through WAN 602. Network module 615 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 615 are performed on the same physical hardware device. In other embodiments (e.g., embodiments that utilize software-defined networking (SDN)), the control functions and the forwarding functions of network module 615 are performed on physically separate devices, such that the control functions manage several different network hardware devices. Computer readable program instructions for performing the inventive methods can typically be downloaded to computer 601 from an external computer or external storage device through a network adapter card or network interface included in network module 615.

WAN 602 is any wide area network (e.g., the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 603 is any computer system that is used and controlled by an end user (e.g., a customer of an enterprise that operates computer 601), and may take any of the forms discussed above in connection with computer 601. EUD 603 typically receives helpful and useful data from the operations of computer 601. For example, in a hypothetical case where computer 601 is designed to provide a recommendation to an end user, this recommendation would typically be communicated from network module 615 of computer 601 through WAN 602 to EUD 603. In this way, EUD 603 can display, or otherwise present, the recommendation to an end user. In some embodiments, EUD 603 may be a client device, such as thin client, heavy client, mainframe computer, desktop computer and so on.

Remote server 604 is any computer system that serves at least some data and/or functionality to computer 601. Remote server 604 may be controlled and used by the same entity that operates computer 601. Remote server 604 represents the machine(s) that collect and store helpful and useful data for use by other computers, such as computer 601. For example, in a hypothetical case where computer 601 is designed and programmed to provide a recommendation based on historical data, then this historical data may be provided to computer 601 from remote database 630 of remote server 604.

Public cloud 605 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 605 is performed by the computer hardware and/or software of cloud orchestration module 641. The computing resources provided by public cloud 605 are typically implemented by virtual computing environments that run on various computers making up the computers of host physical machine set 642, which is the universe of physical computers in and/or available to public cloud 605. The virtual computing environments (VCEs) typically take the form of virtual machines from virtual machine set 643 and/or containers from container set 644. It is understood that these VCEs may be stored as images and may be transferred among and between the various physical machine hosts, either as images or after instantiation of the VCE. Cloud orchestration module 641 manages the transfer and storage of images, deploys new instantiations of VCEs and manages active instantiations of VCE deployments. Gateway 640 is the collection of computer software, hardware, and firmware that allows public cloud 605 to communicate through WAN 602.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 606 is similar to public cloud 605, except that the computing resources are only available for use by a single enterprise. While private cloud 606 is depicted as being in communication with WAN 602, in other embodiments a private cloud may be disconnected from the internet entirely and only accessible through a local/private network. A hybrid cloud is a composition of multiple clouds of different types (e.g., private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 605 and private cloud 606 are both part of a larger hybrid cloud.

FIG. 6 is illustrative of example computer hardware that may be used to implement the inventive arrangements described within this disclosure.

The terminology used herein is for the purpose of describing particular embodiments only and is not intended to be limiting. Notwithstanding, several definitions that apply throughout this document now will be presented.

As defined herein, the terms “at least one,” “one or more,” and “and/or,” are open-ended expressions that are both conjunctive and disjunctive in operation unless explicitly stated otherwise. For example, each of the expressions “at least one of A, B and C,” “at least one of A, B, or C,” “one or more of A, B, and C,” “one or more of A, B, or C,” and “A, B, and/or C” means A alone, B alone, C alone, A and B together, A and C together, B and C together, or A, B and C together.

As defined herein, the term “automatically” means without user intervention.

As defined here, the term “data structure” means a physical implementation of a data model's organization of data within a physical memory. As such, a data structure is formed of specific electrical or magnetic structural elements in a memory. A data structure imposes physical organization on the data stored in the memory as used by an application program executed using a processor.

As defined herein, the terms “includes,” “including,” “comprises,” and/or “comprising,” specify the presence of stated features, integers, steps, operations, elements, and/or components, but do not preclude the presence or addition of one or more other features, integers, steps, operations, elements, components, and/or groups thereof.

As defined herein, the term “if” means “when” or “upon” or “in response to” or “responsive to,” depending upon the context. Thus, the phrase “if it is determined” or “if [a stated condition or event] is detected” may be construed to mean “upon determining” or “in response to determining” or “upon detecting [the stated condition or event]” or “in response to detecting [the stated condition or event]” or “responsive to detecting [the stated condition or event]” depending on the context.

As defined herein, the terms “one embodiment,” “an embodiment,” “in one or more embodiments,” “in particular embodiments,” or similar language mean that a particular feature, structure, or characteristic described in connection with the embodiment is included in at least one embodiment described within this disclosure. Thus, appearances of the aforementioned phrases and/or similar language throughout this disclosure may, but do not necessarily, all refer to the same embodiment.

As defined herein, the term “processor” means at least one hardware circuit configured to carry out instructions. The instructions may be contained in program code. The hardware circuit may be an integrated circuit. Examples of a processor include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, and a controller.

As defined herein, the term “responsive to” means responding or reacting readily to an action or event. Thus, if a second action is performed “responsive to” a first action, there is a causal relationship between an occurrence of the first action and an occurrence of the second action. The term “responsive to” indicates the causal relationship.

The terms first, second, etc. may be used herein to describe various elements. These elements should not be limited by these terms, as these terms are only used to distinguish one element from another unless stated otherwise or the context clearly indicates otherwise.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, comprising:
receiving a user prompt via a user interface, wherein the user prompt is for a generative artificial intelligence system and is specified as natural language;
choosing a selected prompt class from a plurality of prompt classes by matching a natural language processing analysis of the user prompt to a prompt template of the selected prompt class;
creating a well-structured prompt by transforming the user prompt based on the prompt template of the selected prompt class;
generating a conditioned prompt by combining a set of one or more conditioning instructions from the selected prompt class with the well-structured prompt; and
submitting the conditioned prompt to the generative artificial intelligence system, wherein the conditioned prompt is configured to evoke a response including a structured output from the generative artificial intelligence system.

2. The method of claim 1, wherein the prompt template specifies a prompt structure for the conditioned prompt.

3. The method of claim 2, wherein the prompt template includes a field that is populated by a keyword obtained from the natural language processing analysis of the user prompt.

4. The method of claim 1, wherein the generative artificial intelligence system is a large language model.

5. The method of claim 1, wherein the structured output of the generative artificial intelligence system is compatible with a particular computer system and is specific to the selected prompt class.

6. The method of claim 1, wherein the set of one or more conditioning instructions is specific to the selected prompt class.

7. The method of claim 1, wherein the conditioned prompt is configured to reduce non-determinism in the response generated by the generative artificial intelligence system.

8. The method of claim 1, further comprising:
submitting the response from the generative artificial intelligence system to an evaluation system with an evaluator question extracted from the selected prompt class.

9. The method of claim 8, wherein the evaluation system is a generative artificial intelligence system.

10. The method of claim 8, further comprising:
modifying the set of one or more conditioning instructions based on an evaluation result generated by the evaluation system.

11. A system, comprising:
one or more processors configured to execute operations including:
receiving a user prompt via a user interface, wherein the user prompt is for a generative artificial intelligence system and is specified as natural language;
choosing a selected prompt class from a plurality of prompt classes by matching a natural language processing analysis of the user prompt to a prompt template of the selected prompt class;
creating a well-structured prompt by transforming the user prompt based on the prompt template of the selected prompt class;
generating a conditioned prompt by combining a set of one or more conditioning instructions from the selected prompt class with the well-structured prompt; and
submitting the conditioned prompt to the generative artificial intelligence system, wherein the conditioned prompt is configured to evoke a response including a structured output from the generative artificial intelligence system.

12. The system of claim 11, wherein the prompt template specifies a prompt structure for the conditioned prompt.

13. The system of claim 12, wherein the prompt template includes a field that is populated by a keyword obtained from the natural language processing analysis of the user prompt.

14. The system of claim 11, wherein the generative artificial intelligence system is a large language model.

15. The system of claim 11, wherein the structured output of the generative artificial intelligence system is compatible with a particular computer system and is specific to the selected prompt class.

16. The system of claim 11, wherein the set of one or more conditioning instructions is specific to the selected prompt class.

17. The system of claim 11, wherein the conditioned prompt is configured to reduce non-determinism in the response generated by the generative artificial intelligence system.

18. The system of claim 11, wherein the one or more processors are configured to execute operations further comprising:
submitting the response from the generative artificial intelligence system to an evaluation system with an evaluator question extracted from the selected prompt class.

19. The system of claim 18, wherein the one or more processors are configured to execute operations further comprising:
modifying the set of one or more conditioning instructions based on an evaluation result generated by the evaluation system.

20. A computer program product comprising one or more computer readable storage mediums having program instructions embodied therewith, wherein the program instructions are executable by one or more processors to cause the one or more processors to execute operations comprising:
receiving a user prompt via a user interface, wherein the user prompt is for a generative artificial intelligence system and is specified as natural language;
choosing a selected prompt class from a plurality of prompt classes by matching a natural language processing analysis of the user prompt to a prompt template of the selected prompt class;
creating a well-structured prompt by transforming the user prompt based on the prompt template of the selected prompt class;
generating a conditioned prompt by combining a set of one or more conditioning instructions from the selected prompt class with the well-structured prompt; and
submitting the conditioned prompt to the generative artificial intelligence system, wherein the conditioned prompt is configured to evoke a response including a structured output from the generative artificial intelligence system.
